(19) United States
(12) Patent Application Publication
(10) Pub. No.: US 2010/0060615 A1
(43) Pub. Date: Mar. 11, 2010

(54) DIGITAL PHOTO FRAME AND METHOD OF DISPLAYING IMAGE THEREIN

(75) Inventors: Zai-An Pan, Shenzhen City (CN); Xiao-Fang Chen, Shenzhen City (CN); Guang-Jin Li, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/331,412

(22) Filed: Dec. 9, 2008

(30) Foreign Application Priority Data
Sep. 5, 2008 (CN) 200810304386.X

(51) Int. Cl. G09G 5/00

(52) U.S. Cl. 345/204

(57) ABSTRACT

A method for displaying image is provided. The method includes: selecting an image file; reading property values of the selected image file, and displaying the property values of the selected image file on the display; selecting one of the property values in response to a select operation via the input unit, and storing the selected property value as selected image property value; searching the property value of the image files in the memory that match the selected image property value; displaying the found image files.

### TECHNICAL FIELD

The disclosure relates to a digital photo frame and method utilized in the digital photo frame for displaying image.

### DESCRIPTION OF RELATED ART

As we know, digital images play an important role in people's life. Traditionally, in organizing image files, a user creates different classification folders firstly, secondly, the user browses all image files, selects image files and stores the image files into corresponding classification folders, and finally, displaying image files that stored in the classification folders. Obviously, this traditional manner is complicated, and it wastes the user's time and energy. Therefore, what is needed is a digital photo frame capable of displaying image files easily and method thereof.

### SUMMARY

A digital photo frame for displaying image files is provided. The digital photo frame includes an input unit, a memory, a display, and a processor.

The input unit for selecting image files; the memory for storing image files and properties of each of the image files; the processor being connected with the input unit, the memory and the display, includes a property reading module, a determining module, a searching module, and a displaying module. The property reading module is configured for reading property values of a selected image file and displaying the property values of the selected image file on the display; the determining module configured for selecting one of the property values, and storing the selected value as selected image property value; the searching module configured for searching for image files in the memory with a property value matching the selected image property value; the displaying module configured for displaying the found image files.

Other advantages and novel features will be drawn from the following detailed description of the preferred embodiment with references to the attached drawings.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart for a method of displaying image files in accordance with an exemplary embodiment.

FIG. 3 is an exemplary schematic diagram illustrating that the digital photo frame of FIG. 1 is in a state of reminding a user to select a property value as an selected image property value when an image file is selected in accordance with an exemplary embodiment.

### DETAILED DESCRIPTION OF EMBODIMENTS

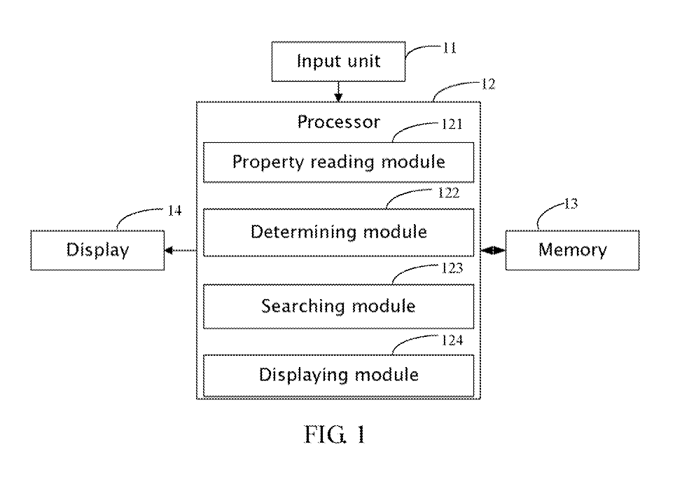

FIG. 1 is a block diagram of a hardware infrastructure of a digital photo frame in accordance with an exemplary embodiment. The digital photo frame includes at least one input unit 11, a processor 12, a memory 13, and a display 14.

The input unit 11 is configured for selecting image files. Especially, when the digital photo frame lists image files on the display 14, the user selects one of the image files via the input unit 11.

The memory 13 is configured for storing image files and properties of each of the image files.

The processor 12 is electrically connected with the input unit 11, the memory 13 and the display 14. The processor 12 includes a property reading module 121, a determining module 122, a searching module 123, and a displaying module 124.

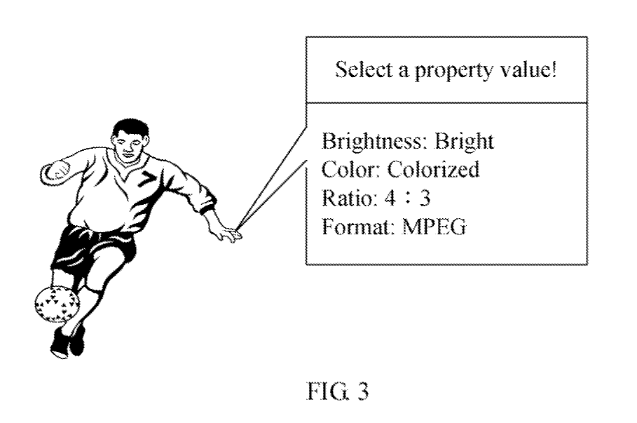

The property reading module 121 is configured for reading property values of a selected image file and displaying the property values of the selected image file on the display 14 (see FIG. 3). The property values include, but are not limited to, at least one of an aspect ratio value, a brightness value, a contrast value, a color value, and a display angle value.

The determining module 122 is configured for selecting one of the property values, thereby yielding selected property value in response to a select operation via the input unit 11, and storing the selected property value as selected image property value. In an exemplary embodiment, the determining module 122 defines a range of the selected property value as selected image property value, for example, if the user defines the ratio value 70% as selected image property value, the image files having ratio values in the range between 65% and 75% match selected image property value.

Furthermore, the determining module 122 is configured for storing the selected image property value in the memory 13. If a selected image property value has been previously in the memory 13, the determining module 122 replaces the previous selected image property value in the memory 13 with the newly defined selected image property value.

The searching module 123 is configured for searching the property values of the image files in the memory 13 that match the selected image property value, thereby retrieving the corresponding image files as found image files.

The displaying module 124 is configured for displaying the found image files.

When the input unit 11 selects another property value as selected image property value, the determining module 122 displays a prompt to remind the user whether to set the selected property value as a selected image property value. If the determining module 122 receives a positive response in a predetermined time period from the user, for example, the input unit 11 is double clicked, the determining module 122 sets the selected property value as the selected image property value. If the determining module 122 does not receive a positive response, the determining module 122 maintains the existing selected image property value.

The digital photo frame further provides a special key for activating the digital photo frame to enter an image display state. The digital photo frame can also provide a menu item for activating the digital photo frame to enter the image display state.

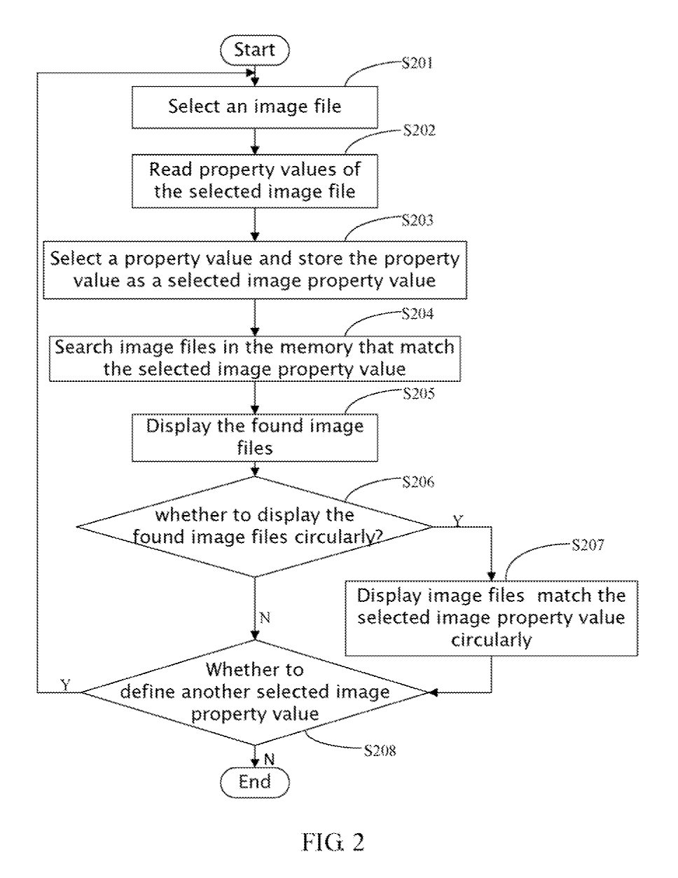

FIG. 2 is a flowchart illustrating a method of displaying image files applied in the digital photo frame of FIG. 1 in accordance with an exemplary embodiment.

In step S201, after the digital photo frame enters the image display mode though the special key or the menu item, the user selects an image file. Specifically, when the digital photo frame lists image files on the screen 14, the user selects an image file via the input unit 11.

In step S202, the property reading module 121 reads the property values of the selected image file.

In step S203, the determining module 122 selects one of the property values, thereby yielding selected property value in response to a select operation via the input unit 11, and storing the selected property value as a selected image property value. Furthermore, if a selected image property value has been previously in the memory 13, the determining module 122 replaces the previous selected image property value in the memory 13 with the newly defined selected image property value.

In step S204, the searching module 123 searches the property value of the image files in memory that match the selected image property value, thereby retrieving corresponding image files as found image files. In step S205, the displaying module 124 displays the found image files.

In step S206, when the displaying module 124 displays the found image files, the displaying module 124 displays a prompt to remind the user whether to display the image files matching the selected image property value circularly.

In step S207, if the displaying module 124 receives the operation of displaying the image files circularly, the displaying module 124 displays the image files that match the selected image property value circularly.

In step S208, if the displaying module 124 does not receive any response, the determining module 122 further determines whether to define another selected image property value. If the determining module 122 does not receive response to define another selected image property value, and the procedure is ended.

If the determining module 122 determines to define another selected image property value, the procedure returns to step S201.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. A digital photo frame (DPF) for displaying image, comprising:
a display;
an input unit for entering user input;
a memory for storing image files and property values of the image files; and
a processor being connected with the display, the input unit and the memory, comprising:
a property reading module configured for reading property values of a selected image file and displaying the property values of the selected image file on the display;
a determining module configured for selecting one of the property values, and storing the selected property value as selected image property value;
a searching module configured for searching the property values of the image files in the memory that match the selected image property value, and retrieving the corresponding image files that have a property value matching the selected property value; and
a displaying module configured for displaying the retrieved image files on the display.

2. The DPF as described in claim 2, wherein the property values of an image file comprise at least one of an aspect radio value, a brightness value, a contrast value, a color value, or a display angle value.

3. The DPF as described in claim 2, wherein the selected image property value is a range of a property value.

4. A method of displaying image files applied on a digital photo frame (DPF) which includes:
a display;
an input unit; and
a memory for storing image files;
the method comprising:
selecting an image file via the input unit;
reading property values of the selected image file, and displaying the property values of the selected image file on the display;
selecting one of the property values in response to a select operation via the input unit, and storing the selected property value in the memory as selected image property value;
searching the property values of the image files in the memory that match the selected image property value and retrieving the corresponding image file with a property value matching the selected property value as found images file; and
displaying the found image files.

5. The method as described in claim 4, wherein the storing the selected property value step comprises: replacing a existing selected image property value in the memory with the newly defined selected image property value if a selected image property value exists in the memory.

6. The method as described in claim 4, wherein the storing the selected property value step comprises: displaying a prompt to remind a user whether to define the selected property value as the selected image property value.

7. The method as described in claim 4, further comprising: when the image files with a property value matching the selected image property value are displayed, displaying a prompt to remind the user whether to display the image files circularly; displaying the image files circularly if a positive response is received, and determining whether to define another selected image property value if the image files are not to be displayed circularly.

8. The method as described in claim 7, wherein the step of determining whether to define another selected image property value further comprises: selecting another property value and storing the selected property value as the current selected image property value if defining another selected image property value is determined.
